(19) United States
(12) Patent Application Publication
(10) Pub. No.: US 2026/0267683 A1
(43) Pub. Date: Sep. 10, 2026

(54) WORKER NODES COOPERATIVELY PERFORMING A TASK

(71) Applicant: Telefonaktiebolaget LM Ericsson (PUBL), Stockholm (SE)

(72) Inventors: Yu LIU, Sundbyberg (SE); Aitor HERNANDEZ HERRANZ, STOCKHOLM (SE)

(21) Appl. No.: 18/993,386

(22) PCT Filed: Jul. 15, 2022
(86) PCT No.: PCT/EP2022/069952

§ 371 Date: Jan. 10, 2025

(51) Int. Cl. G06F 9/48

(52) U.S. Cl. CPC G06F 9/4843

(57) ABSTRACT

The disclosure relates to a method of a worker node (102) of cooperatively performing a task with at least one other worker node (103) in a group, a method of a group of worker nodes (102, 103) configured to cooperatively perform a task, and worker nodes (102, 103) performing the methods. The disclosure further relates to a computer program and a computer program product.

Provided is a method of a worker node (102) of cooperatively performing a task with at least one other worker node (103) in a group. The method comprises acquiring (S101a), from a control node (101) configured to perform service deployment of the worker nodes (102, 103) of the group, deployment information for at least one service to be executed by the worker nodes of the group for cooperatively performing the task, detecting (S103) a communication connectivity loss to the control node (101), determining (S105) whether or not said at least one other worker node (103) requires service redeployment for being capable of cooperatively performing the task, and if so to redeploying (S106) said at least one other worker node (103) with said at least one service to be executed by said at least one other worker node (103) to cooperatively perform the task.

### TECHNICAL FIELD

The present disclosure relates to a method of a worker node of cooperatively performing a task with at least one other worker node in a group, a method of a group of worker nodes configured to cooperatively perform a task, and worker nodes performing the methods. The present disclosure further relates to a computer program and a computer program product.

### BACKGROUND

Deployment of Extended Reality (XR) applications, such as Virtual Reality (VR), Augmented Reality (AR), and Mixed Reality (MR), or robotics applications is continuously increasing and entails new requirements for hardware, devices, networks and storage solutions. Increasing popularity of these applications also involves a need for scalable solutions which usually are overlooked fields.

In robotics applications, flexibility in the lifecycle of an application executed by one or more robotic device are typically not prioritized neither in the robotic devices themselves nor in the configuration of the application being executed inside the devices or device configuration options. A trend appears to be to bring cloud native technologies closer to the Robotics Operating System (ROS) and approaches to integrate that in cloud domains.

There are existing solutions that provide systems where a control node controls and orchestrates a plurality of worker nodes for executing a particular application, such has Kubernetes. Examples of frameworks that expand or replace Kubernetes to include more advanced worker node cluster management are KubeEdge, Fog05 or Nomad by HashiCorp.

A problem with existing workload orchestration systems is that their functionality to a great extent depends on stable and robust connectivity between the supervising control node and the cluster of worker nodes being assigned by the control node to execute an application.

### SUMMARY

One objective is to solve, or at least mitigate, this problem in the art and thus to provide an improved method of a worker node of cooperatively performing a task with at least one other worker node in a group.

This objective is attained in a first aspect by a method of a worker node of cooperatively performing a task with at least one other worker node in a group. The method comprises acquiring, from a control node configured to perform service deployment of the worker nodes of the group, deployment information for at least one service to be executed by the worker nodes of the group for cooperatively performing the task, detecting a communication connectivity loss to the control node, determining whether or not said at least one other worker node requires service redeployment for being capable of cooperatively performing the task, and if so redeploying said at least one other worker node with said at least one service to be executed by said at least one other worker node to cooperatively perform the task.

This objective is attained in a second aspect by a worker node configured to cooperatively perform a task with at least one other worker node in a group, the worker node comprising a processing unit and a memory, said memory containing instructions executable by said processing unit, whereby the worker node is operative to acquire, from a control node configured to perform service deployment of the worker nodes of the group, deployment information for at least one service to be executed by the worker nodes of the group for cooperatively performing the task, detect a communication connectivity loss to the control node, determine whether or not said at least one other worker node requires service redeployment for being capable of cooperatively performing the task, and if so to redeploy said at least one other worker node with said at least one service to be executed by said at least one other worker node to cooperatively perform the task.

This objective is attained in a third aspect by a method of a group of worker nodes configured to cooperatively perform a task. The method comprises acquiring, from a control node configured to perform service deployment of the worker nodes of the group, deployment information for at least one service to be executed by the worker nodes of the group for cooperatively performing the task, detecting a communication connectivity loss to the control node, assigning one of the worker nodes as being responsible for redeploying one or more of the remaining worker nodes in the group, determining whether or not at least one other worker nodes requires service redeployment for being capable of cooperatively performing the task, and if so redeploying said at least one other worker node with said at least one service to be executed by said at least one other worker node to cooperatively perform the task.

This objective is attained in a fourth aspect by a group of worker nodes configured to cooperatively perform a task, the worker nodes each comprising a processing unit and a memory, said memory containing instructions executable by said processing unit, whereby the worker nodes are operative to acquire, from a control node configured to perform service deployment of the worker nodes of the group, deployment information for at least one service to be executed by the worker nodes of the group for cooperatively performing the task, detect a communication connectivity loss to the control node, assign one of the worker nodes as being responsible for redeploying one or more of the remaining worker nodes in the group, determine whether or not at least one other worker nodes requires service redeployment for being capable of cooperatively performing the task, and if so to redeploy said at least one other worker node with said at least one service to be executed by said at least one other worker node to cooperatively perform the task.

Advantageously, by allowing a worker node in a group (a so-called leader node) to redeploy a failed service at another worker node in the group, said another worker node in the group may still cooperatively perform the assigned task autonomously even in case of communication connectivity loss to the control node.

In an embodiment, the method further comprises storing the acquired deployment information locally to enable access to said deployment information to the worker nodes in the group.

In an embodiment, the storing of the acquired deployment information is preceded by receiving the deployment information from the control node.

In an embodiment, the storing of the acquired deployment information is preceded by replicating the deployment information across the worker nodes of the group.

In an embodiment, the method further comprises assigning to one of the worker nodes in the group a responsibility to perform service redeployment of any one of the remaining worker nodes in the group.

In an embodiment, the assigning to one of the worker nodes in the group a responsibility to perform service redeployment further comprises assigning a rank among the worker nodes in the group indicating which worker node should perform service redeployment of the remaining worker nodes in the group, wherein in case a highest ranked worker node requires service redeployment, a next-highest ranked worker node will perform the service redeployment.

In an embodiment, in case said at least one other worker node cannot be successfully redeployed, at least one remaining work node in the group is redeployed with said at least one service of said at least one other worker node to enable said at least one remaining work node to perform the service of said at least one other worker node which cannot be successfully redeployed, in addition to its own individual service.

In an embodiment, the method further comprises locally storing any changes being made regarding on which of the worker nodes in the group said at least one service is being redeployed, to enable access to the changes being made to all worker nodes in the group.

In an embodiment, the method further comprises providing the control node with information indicating said any changes having been made regarding on which of the worker nodes in the group said at least one service is being redeployed once the communication connectivity is restored.

In a further aspect, computer programs comprising computer-executable instructions for causing the worker node(s) to perform steps recited in the methods according to the first and third aspects, respectively, when the computer-executable instructions are executed on processing units included in the worker nodes.

In still an aspect, computer program products comprising computer readable mediums are provided having the computer programs of said further aspect embodied thereon.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates a workload orchestration system in which embodiments may be implemented;

FIG. 2 illustrates worker nodes according to an embodiment being connected to a control node;

FIG. 3 illustrates worker nodes according to an embodiment being disconnected from a control node;

FIG. 4 shows a signalling diagram illustrating a method of a group of worker nodes of cooperatively performing a task according to an embodiment;

FIG. 5 shows a signalling diagram illustrating a method of a group of worker nodes of cooperatively performing a task according to a further embodiment;

FIG. 6 shows a signalling diagram illustrating a method of a group of worker nodes of cooperatively performing a task according to another embodiment; and

FIG. 7 illustrates a worker node according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

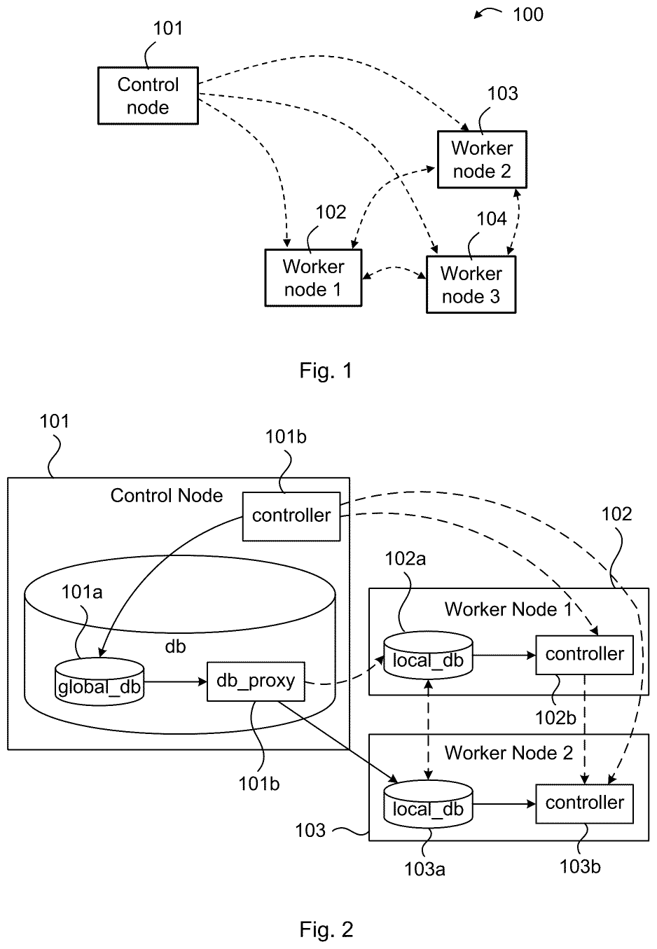

FIG. 1 illustrates a workload orchestration system 100 where a control node 101 is configured to supervise a plurality of worker nodes 102-104 being assigned by the control node 101 to cooperatively perform an application or task, in which embodiments may be implemented.

In an example, the worker nodes 102-104 may be robotic devices cooperatively performing a task such as manufacturing a car on an assembly line, where a first robot 102 performs a first service of mounting the vehicle frame while a second robot 103 performs a second service of assembling the chassis and a third robot 104 performs a third service of fitting components such as axles and rims to the vehicle frame. As is understood, such a workload orchestration system may involve a great number of robots performing various services for cooperatively performing the task of assembling the car. In other words, a number of sub-tasks in the form of provided services being executed in order to cooperatively perform an assigned task or application.

In another example, the worker nodes 102-104 are servers cooperating to perform a processing task such as computing a great workload. In practice, the worker nodes may run one or many workloads concurrently.

The control node 101 and the worker nodes 102-104 together form a cluster, in which the control node 101 is responsible for ensuring that correct information is available to the worker nodes 102-104 in order for the worker nodes to perform the adequate service(s) required for cooperatively performing the assigned task as described hereinabove. As is understood, each worker node 102-104 may execute its own individual service(s) or the same service(s) as other worker nodes 102-104 in the cluster.

Further, in a cluster, the worker nodes 102-104 may execute several services for cooperatively performing the task. For instance, a task to be performed may require several services to be provided. Assuming that task X requires five different services to be provided; two may be performed by first worker node 102, while another two is performed by second worker node 103 and one is performed by third worker node 104.

Thus, each worker node 102-104 would in practice typically by deployed with one or more designated services to be executed, but it may also be envisaged that a plurality of worker nodes is deployed with the same service(s), or even that all worker nodes in a cluster are deployed with a same single service or group of services.

Once the services are deployed in the cluster, the services execute independently on the worker nodes 102-104. As is understood, any software components required by the worker nodes 102 for executing one or more services for cooperatively performing a task is typically not downloaded to the worker nodes by the central node.

Rather, a cluster operator provides the worker nodes with the required software component required for executing the services. However, if for instance a service failure would occur at one or more of the worker nodes 102-104, thereby making the worker node incapable of performing the required service, the control node 101 is responsible for performing service redeployment at the worker node.

In this context, service redeployment may comprise numerous activities to be undertaken by the control node 101 in addition to just effecting a service restart at a worker node including for instance life cycle management of the services, rescheduling and migration of services if worker node resources are not enough at some point, clean-up of resources for the service, etc. From a general point of view, the control node 101 is responsible for orchestrating services to be executed by the worker nodes 102-104. In other words, with the service deployment, the control node 101 ensures the availability of the cooperatively performed task through the orchestration of the services.

Now, in the workload orchestration system 100 of FIG. 1, a loss of connectivity occurring between the control node 101 and the worker nodes 102-104 may be fatal for the cooperatively performed task of the worker nodes 102-104 in that the control node 101 will not be capable of redeploying a service having crashed on one or more of the worker nodes 102-104 in the cluster. This will typically halt the cooperative task performed by the worker nodes 102-104 since any given worker node typically is dependent on the service performed by any other worker node in the cluster.

FIG. 2 illustrates worker nodes according to an embodiment being connected to a control node, where a cluster is shown comprising control node 101, a first worker node 102 and a second worker 103. As is understood, the cluster may in practice comprise a great number of worker nodes.

As described above, the control node 101 is a centralized management node responsible for ensuring that all services are being executed on the worker nodes 102, 103 and hosts a global database 101a, i.e. a distributed database containing deployment and scheduling details as regards the services to be executed by the worker nodes 102, 103 for cooperatively performing an assigned task. The deployment and scheduling details include for instance resource requirements for a worker node to be able to execute a service, any service dependency with respect to services executing on other worker nodes, which worker node a given service is executed on, health status, etc.

The control node 101 further comprises a controller 101b responsible for triggering the execution of any services deployed to the worker nodes 102, 103 via a database proxy 101c in line with the above described service orchestration concept.

The database proxy 101c listens (as part of a replication mechanism of the global database 101a) to all the replication events, operations, or changes, and provides the necessary deployment details for services and any updates to a local database 102a, 103a of the first worker node 102 and the second worker node 103, respectively. Advantageously, the required deployment details for the services required to be executed for cooperatively performing the assigned task of the cluster are thus kept consistent and available across all nodes 101, 102, 103.

Each worker node 102, 103 further comprises a controller 102b, 103b configured to execute the deployed service(s) such that each worker node 102, 103 may perform a sub-task required for cooperatively performing the main task assigned to the cluster.

In line with the previously stated example where the main task of the cluster is to assemble a car, the service/sub-task provided by the first worker node 102 may be to mount the car frame while the service of the second worker node 103 may be to assemble the chassis.

As is understood, the controllers 102b, 103b of the worker nodes 102, 103 may interact to cooperatively perform the task assigned to the cluster.

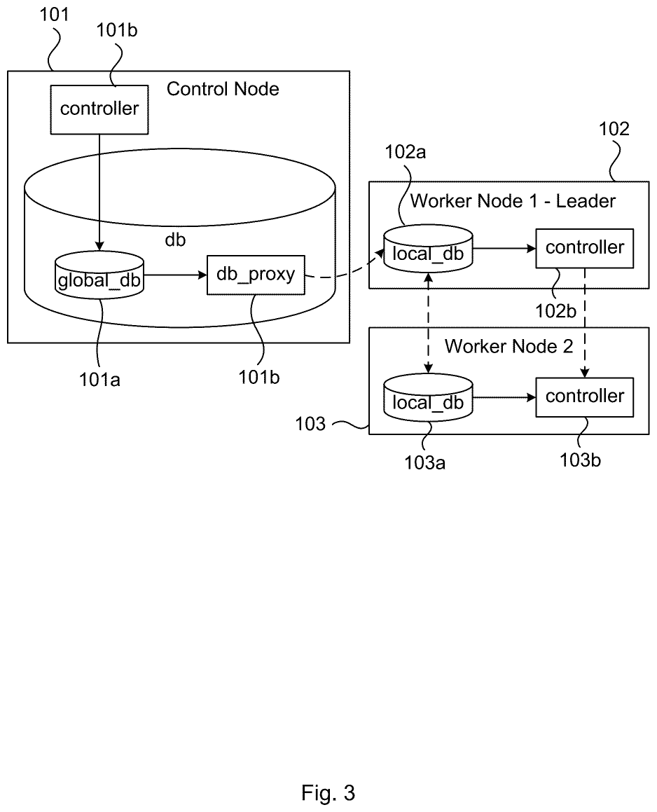

FIG. 3 illustrates a scenario where the connectivity between the control node 101 and the worker nodes 102, 103 is lost.

With the setup described with reference to the embodiment of FIG. 2, it is still possible for the worker nodes 102, 103 to ensure service availability for carrying on the assigned task when the connectivity to the control node 101 is lost, even in case there are service failures occurring at a worker node.

This is performed by creating a sub-cluster independent from the control node 101 where one of the worker nodes is assigned the role of a leader worker node 102 responsible for redeploying one or more services on a failed worker node in the created sub-cluster.

As is understood, in the prior art there are typically local mechanisms implemented by the controllers 102b, 103b of the respective worker node 102, 103 to maintain execution of an application to perform an assigned sub-task in case the connectivity to the control node 101 is lost. However, worker nodes losing connectivity to the control node will act independently and there is no possibility to perform service redeployment by the control node. There may be numerous reasons for this, such as service failure or resource consumption/network latency above a critical threshold, and in some cases, the service/sub-task itself needs to be continuously scheduled to execute in a correct manner.

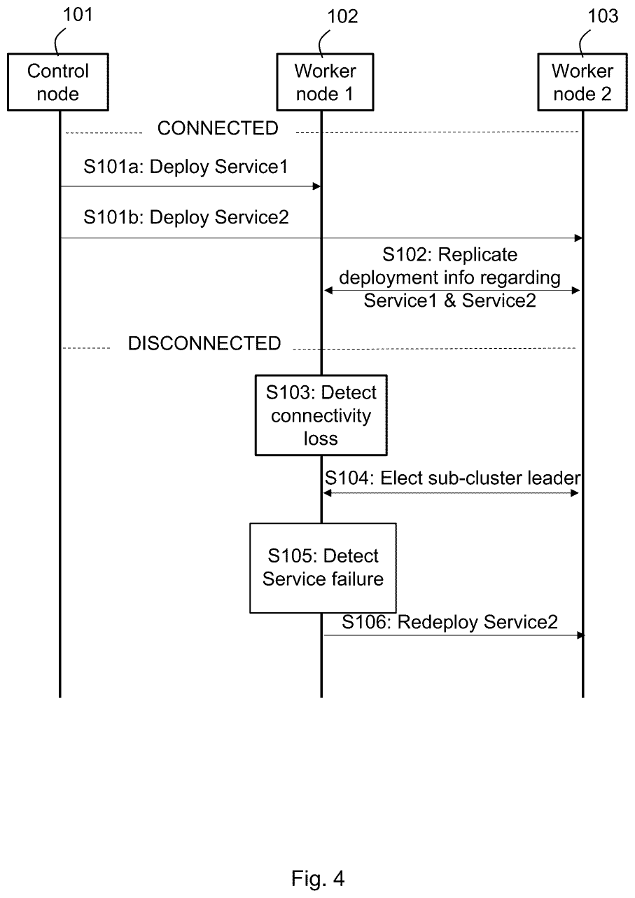

FIG. 4 shows a signalling diagram illustrating a method of a group of worker nodes of cooperatively performing a task according to an embodiment.

In steps S101a and S101b, the control node 101 performs service deployment. In a simplified example, this may include indicating to the worker nodes 102-103 which particular service to be executed among numerous services which potentially may be provided by each worker node. As previously described, a practical scenario would typically include more elaborate instructions with the service deployment for one or more indicate services, such as e.g. resource assignment, service dependency and life-cycle management.

Thus, in this exemplifying embodiment, service deployment is performed by the control node 101 by indicating a first service to be executed by the first worker node 102 in step S101a and a second service to be executed by the second worker node 103. As is understood, the first worker node 102 executes the first service while the second worker node 103 executes the second service, the first service (“mount frame”) and the second service (“assemble chassis”) being performed to cooperatively perform an assigned task (“assemble vehicle”) of the cluster.

As is understood, as long as the connection between the control node 101 and the worker nodes is maintained, it is possible for the control node to perform service updates and perform service redeployment if any service in the cluster should crash or fail.

As soon as a service deployment or update is performed by the control node 101 as reflected in its global database 101a, the service deployment information is replicated across all worker nodes 102, 103 in step S102 to keep the local databases 102a, 103a up to date at any time. As is understood, the worker nodes 102, 103 may also exchange operational data related to the service being performed by each worker node, such as a current state of each worker node 102, 103.

In an alternative, rather than having the worker nodes 102, 103 exchange the service deployment information in step S102, the control node 101 may supply the first worker node 102 with the second service deployment information in step S101a and further supply the second worker node 102 with the first service deployment information in step S101b, for provision to the respective local database 102a, 103a.

Assuming that a connectivity loss occurs due to e.g. a network failure, one or more of the worker nodes-in this example the first worker node 102—detects in step S103 that there is a communication connectivity loss to the control node 101. In case of network failure, the worker nodes may in an embodiment attempt to establish communication over a different radio access technology (RAT).

At this stage, the control node 101 may pause any updating of deployment information for services in the global database 101a to avoid consistency issues, or even remove the service deployment information from the global database 101a. Thus, upon the connectivity loss occurring, it is no longer the responsibility of the control node 101 to ensure service availability among the worker nodes 102, 103 for carrying on the assigned task.

Thereafter, the first worker node 102 creates a sub-cluster by engaging in a leader election process with the other worker nodes in step S104 (in this example the second worker node 103).

As mentioned, a cluster may in practice comprise a great number of worker nodes and in case of connectivity loss due to a network failure, a plurality of these worker nodes may not be capable of joining the sub-cluster since they no longer are connected. As is understood, the leader election is preceded by the worker nodes discovering which other worker nodes still have connectivity. Any appropriate peer discovery technique may be used by the worker nodes for checking connectivity to other worker nodes in the cluster.

In this exemplifying embodiment, the first worker node 102 is elected to be sub-cluster leader utilizing any appropriate leader election process such as a ring, mesh or hypercube election process.

As is understood, the service deployment information may include policies or conditions to facilitate and guide the deployment process. For example, it may indicate which are central services for cooperatively performing the task and which are secondary services.

Once the first worker node 102 is elected leader, any service changes and/or redeployment may be undertaken by the first worker node 102. Assuming for instance that a service failure occurs at the second worker node 103 as detected by the first worker node 102 in step S104, the first worker node 102 will access its local database 102a for the deployment information associated with the second service that was executed by the second worker node 103 before the service failure (as replicated across the local databases 102a, 103a in step S102) and perform redeployment of the second service at the second worker node 103.

Advantageously, with this embodiment, the worker nodes 102, 103 of the sub-cluster may still cooperatively perform the assigned task autonomously even in case of communication connectivity loss to the control node 101 and service failure occurring at one of the worker nodes 102, 103.

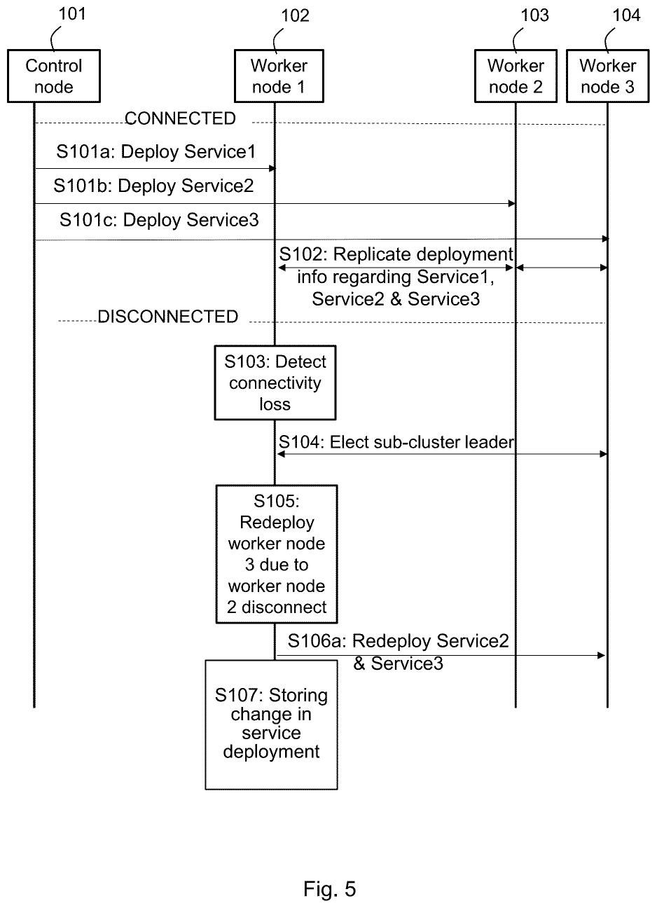

With reference to FIG. 5 showing a signalling diagram illustrating a method of a group of worker nodes of cooperatively performing a task according to a further embodiment, assuming that the cluster comprises three worker nodes 102-104, the third worker node 104 being deployed with a third service in step S101c.

Assuming further that there also is a connectivity loss to the second worker node 104 in addition to the connectivity loss with the control node 101, and that the first worker node 102 and the third worker node 104 creates a sub-cluster in step S104.

Any attempt to redeploy the second worker node 103 will be unsuccessful (unless the connection of the second worker node 103 would be restored), and the first worker node 102 may conclude that any service performed by the second worker node 103 (i.e. the second service) now may have to be performed by the first worker node 102 and/or the third worker node 103.

In other words, with reference to FIG. 5, the workload of the disconnected second worker node 103 would have to be distributed over the first worker node 102 and/or the third worker node 104. If so, it would typically not be sufficient to perform redeployment with a previously deployed service. For instance, assuming that the first worker node 102 determines that the third worker node 104 is to perform the service of the disconnected second worker node 103, the first worker node 102 will deploy the third worker node 104 with the third service as well as the second service previously executed by the now disconnected second worker node 103 in order for the third worker node 104 to take over second service execution from the second worker node 103, as illustrated in step S106a.

In a further embodiment also illustrated with reference to FIG. 5, if a change has occurred in service deployment, e.g. by deploying the third worker node 104 with the second and the third service due to the second worker node 103 being disconnected as undertaken in step S106a, an indication of said service deployment change is stored e.g. in local database 102a of the first worker node 102 (and possibly also at the third worker node 104) for subsequent provision to the control node 101.

That is, the control node 101 will advantageously be informed that the third worker node 104 not only executes the third service, but further also executes the second service on behalf of the second worker node 103.

In a further embodiment, when assigning in step S104 to one of the worker nodes in the group a responsibility to perform redeployment of any one of the remaining worker nodes in the group, a rank may be assigned among the worker nodes in the group indicating which worker node should perform service redeployment of the remaining worker nodes in the group, wherein in case a highest ranked worker node requires service redeployment, a next-highest ranked worker node will perform the service redeployment.

Thus, in an example, the first worker node 102 may be given the highest (leader) rank, the second worker node 103 may be given the next-highest rank, the third worker node 104 may be given the third-highest rank, and so on.

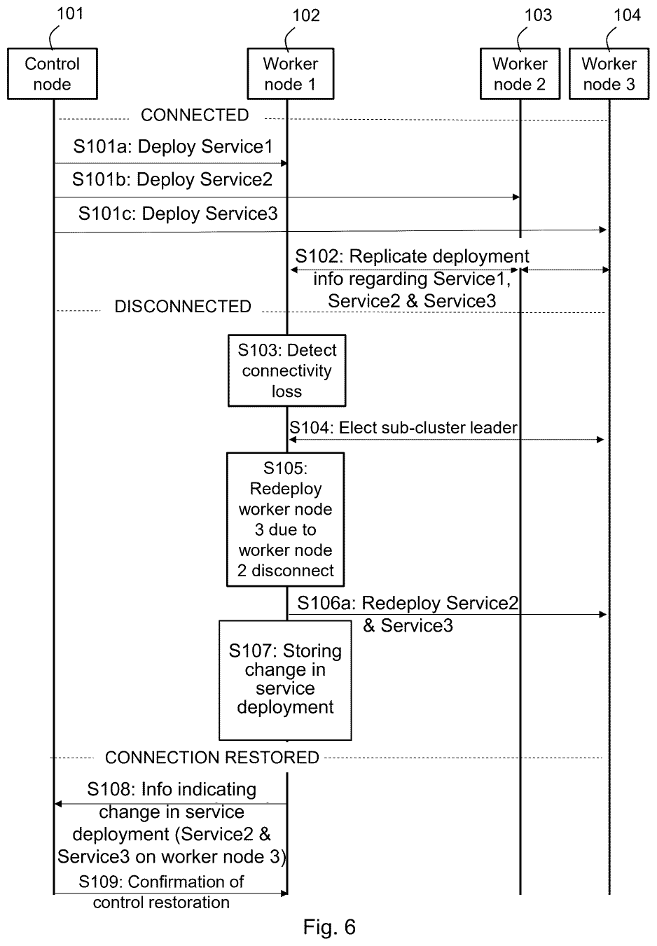

FIG. 6 illustrates a further embodiment where the first worker node 102 provides the control node 101, upon the connectivity being restored, with information in step S108 indicating the changes having been as regards service deployment.

In this exemplifying embodiment, the first worker node 102 informs the control node 101 that the third worker node 104 has been redeployed with the second service and the third service such that the control node 101 may update the global database 101a accordingly to reflect the current state of the cluster.

Hence after having performed a cluster split-by forming a sub-cluster excluding the disconnected control node 101 and any disconnected worker nodes the sub-cluster has now advantageously been merged with the control node 101 to again form a full cluster managed by the control node 101, wherein the first worker node 102 is resigned from the role as a leader node and reverts to being a regular worker node upon receiving a confirmation from the control node 101 in step S109.

Advantageously, database consistency during split-merge is maintained. With the deployment changes confirmed in step S108, control is restored by the control node 101. Depending on the policies, the control node 101 could imply a rescheduling of the workloads or maintain the current deployment.

In an alternative, again with reference e.g. to FIG. 6, rather than having the worker nodes 102, 103, 104 in the sub-cluster elect a leader worker node in step S104, a leader node is elected in advance, for example the first worker node 102. If so, only the first worker node will have to maintain a local database 102a. However, if the first worker node 102 then would disconnect along with the control node 101, the remaining worker nodes may not be able to autonomously manage the sub-cluster. However, in such an alternative, the most robust worker node in the cluster with respect to e.g. processing power and connective capacity would be elected leader node.

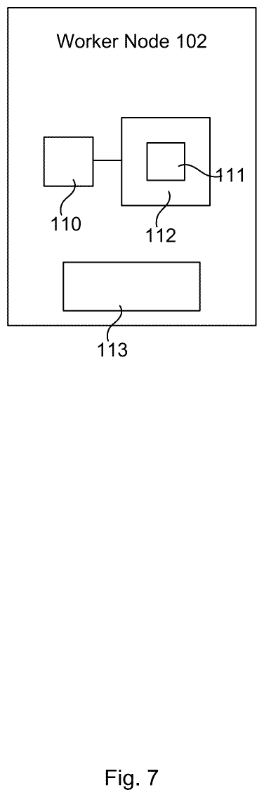

FIG. 7 illustrates a worker node 102 configured to cooperatively performing a task with at least one other worker node in a group according to an embodiment. The steps of the method performed by the worker node 102 are in practice performed by a processing unit 110 embodied in the form of one or more microprocessors arranged to execute a computer program 111 downloaded to a suitable storage volatile medium 112 associated with the microprocessor, such as a Random Access Memory (RAM), or a non-volatile storage medium such as a Flash memory or a hard disk drive. The processing unit 110 is arranged to cause the worker node 102 to carry out the method according to embodiments described herein, when the appropriate computer program 111 comprising computer-executable instructions is downloaded to the storage medium 112 and executed by the processing unit 110. The storage medium 112 may also be a computer program product comprising the computer program 111. Alternatively, the computer program 111 may be transferred to the storage medium 112 by means of a suitable computer program product, such as a Digital Versatile Disc (DVD) or a memory stick. As a further alternative, the computer program 111 may be downloaded to the storage medium 112 over a network. The processing unit 110 may alternatively be embodied in the form of a digital signal processor (DSP), an application specific integrated circuit (ASIC), a field-programmable gate array (FPGA), a complex programmable logic device (CPLD), etc. The worker node 102 further comprises an interface 113 over which data may be received and transmitted to the control node and other worker nodes.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of a worker node of cooperatively performing a task with at least one other worker node in a group, comprising:
acquiring, from a control node configured to perform service deployment of the worker nodes of the group, deployment information for at least one service to be executed by the worker nodes of the group for cooperatively performing the task;
detecting a communication connectivity loss to the control node;
determining whether or not said at least one other worker node requires service redeployment for being capable of cooperatively performing the task; and if so
redeploying said at least one other worker node with said at least one service to be executed by said at least one other worker node to cooperatively perform the task.

2. The method of claim 1, further comprising:
storing the acquired deployment information locally to enable access to said deployment information to the worker nodes in the group.

3. The method of claim 2, the storing of the acquired deployment information being preceded by receiving the deployment information from the control node.

4. The method of claim 2, the storing of the acquired deployment information being preceded by replicating the deployment information across the worker nodes of the group.

5. The method of claim 1, further comprising:
assigning to one of the worker nodes in the group a responsibility to perform service redeployment of any one of the remaining worker nodes in the group.

6. The method of claim 5, the assigning to one of the worker nodes in the group a responsibility to perform service redeployment further comprising:
assigning a rank among the worker nodes in the group indicating which worker node should perform service redeployment of the remaining worker nodes in the group, wherein in case a highest ranked worker node requires service redeployment, a next-highest ranked worker node will perform the service redeployment.

7. The method of claim 1, further comprising, in case said at least one other worker node cannot be successfully redeployed:
redeploying at least one remaining work node in the group with said at least one service of said at least one other worker node to enable said at least one remaining work node to perform the service of said at least one other worker node which cannot be successfully redeployed, in addition to its own individual service.

8. The method of claim 7, further comprising:
locally storing any changes being made regarding on which of the worker nodes in the group said at least one service is being redeployed, to enable access to the changes being made to all worker nodes in the group.

9. The method of claim 8, further comprising:
providing the control node with information indicating said any changes having been made regarding on which of the worker nodes in the group said at least one service is being redeployed once the communication connectivity is restored.

10. The method of claim 1, further comprising:
receiving a confirmation that the control node has retained control of the service deployment for the group of worker nodes.

11. (canceled)

12. A computer program product comprising a computer readable medium the computer readable medium having the computer program comprising computer-executable instructions for causing a worker node to perform steps recited in claim 1, when the computer-executable instructions are executed on a processing unit included in the worker node.

13. (canceled)

14. A worker node configured to cooperatively perform a task with at least one other worker node in a group, the worker node comprising a processing unit and a memory, said memory containing instructions executable by said processing unit whereby the worker node is operative to:
acquire, from a control node configured to perform service deployment of the worker nodes of the group, deployment information for at least one service to be executed by the worker nodes of the group for cooperatively performing the task;
detect a communication connectivity loss to the control node;
determine whether or not said at least one other worker node requires service redeployment for being capable of cooperatively performing the task; and if so to
redeploy said at least one other worker node with said at least one service to be executed by said at least one other worker node to cooperatively perform the task.

15. The worker node of claim 14, further being operative to:
store the acquired deployment information locally to enable access to said deployment information to the worker nodes in the group.

16. The worker node of claim 15, further being operative to, preceding to storing the acquired deployment information, receive the deployment information from the control node.

17. The worker node of claim 15, further being operative to, preceding to storing the acquired deployment information, replicate the deployment information across the worker nodes of the group.

18. The worker node of claim 14 further being operative to:
assign to one of the worker nodes in the group a responsibility to perform service redeployment of any one of the remaining worker nodes in the group.

19. The worker node of claim 18, further being operative to, when assigning to one of the worker nodes in the group a responsibility to perform service redeployment:
assign a rank among the worker nodes in the group indicating which worker node should perform service redeployment of the remaining worker nodes in the group, wherein in case a highest ranked worker node requires service redeployment, a next-highest ranked worker node will perform the service redeployment.

20. The worker node of claim 14 further being operative to, in case said at least one other worker node cannot be successfully redeployed:
redeploy at least one remaining work node in the group with said at least one service of said at least one other worker node to enable said at least one remaining work node to perform the service of said at least one other worker node which cannot be successfully redeployed, in addition to its own individual service.

21. The worker node of claim 20, further being operative to:
locally store any changes being made regarding on which of the worker nodes in the group said at least one service is being redeployed, to enable access to the changes being made to all worker nodes in the group.

22.-23. (canceled)

24. A group of worker nodes configured to cooperatively perform a task, the worker nodes each comprising a processing unit and a memory, said memory containing instructions executable by said processing unit, whereby the worker nodes are operative to:
acquire, from a control node configured to perform service deployment of the worker nodes of the group, deployment information for at least one service to be executed by the worker nodes of the group for cooperatively performing the task;
detect a communication connectivity loss to the control node;
assign one of the worker nodes as being responsible for redeploying one or more of the remaining worker nodes in the group;
determine whether or not at least one other worker nodes requires service redeployment for being capable of cooperatively performing the task; and if so to
redeploy said at least one other worker node with said at least one service to be executed by said at least one other worker node to cooperatively perform the task.
